(19) United States
(12) Patent Application Publication
(10) Pub. No.: US 2026/0237869 A1
(43) Pub. Date: Aug. 13, 2026

(54) ELECTRODE PLATE, SECONDARY BATTERY, AND ELECTRIC DEVICE

(71) Applicant: Ningde Amperex Technology Limited, Ningde (CN)

(72) Inventors: Chu HUANG, Ningde (CN); Sen LIN, Ningde (CN)

(73) Assignee: Ningde Amperex Technology Limited, Ningde (CN)

(21) Appl. No.: 19/638,147

(22) Filed: Apr. 3, 2026

(30) Foreign Application Priority Data
Apr. 3, 2024 (CN) 202510421509.1

(51) Int. Cl. H01M 50/538; H01M 4/70; H01M 10/0587; H01M 50/105; H01M 50/474

(52) U.S. Cl. CPC H01M 50/538; H01M 4/70; H01M 10/0587; H01M 50/105; H01M 50/474

(57) ABSTRACT

An electrode plate includes a current collector. On a side in a width direction of the current collector, the current collector is provided with a plurality of first slots and a plurality of second slots. Each of the first slots is provided with one tab or two tabs that are spaced, and the second slot is provided with no tab. In a length direction of the current collector, an odd number of second slots are provided between adjacent two of the first slots.

### CROSS-REFERENCE TO RELATED APPLICATION

This application claims priority to the Chinese Patent Application Serial No. 202510421509.1, filed on Apr. 3, 2025, the content of which is incorporated herein by reference in its entirety.

### TECHNICAL FIELD

This application relates to the field of energy storage technologies, and in particular, to an electrode plate, a secondary battery, and an electric device.

### BACKGROUND

Currently, a secondary battery includes a housing and an electrode assembly provided in the housing, where the electrode assembly includes a positive electrode plate, a negative electrode plate, and a separator separating the positive electrode plate and the negative electrode plate. Based on the stacking manners and manufacturing processes of positive electrode plates, negative electrode plates, and separators, electrode assemblies can be classified into laminated electrode assemblies and wound electrode assemblies. Generally, polarities of both laminated electrode assemblies and wound electrode assemblies are led out through tabs.

### SUMMARY

For secondary batteries in the prior art, the inventors have found that a current positive tab is electrically connected to a positive electrode plate and extends out of an edge of the positive electrode plate, a negative tab is electrically connected to a negative electrode plate and extends out of an edge of the negative electrode plate, and the extended positive tab and negative tab occupy some additional space, resulting in an increase in a size of the secondary battery in an extending direction of the tab (that is, a length direction or width direction of the secondary battery). As a result, energy density of the secondary batteries in the prior art needs to be improved.

In view of the foregoing situation, it is necessary to provide an electrode plate to improve the energy density of secondary batteries.

A first aspect of this application provides an electrode plate, including a current collector. On a side in a width direction of the current collector, the current collector is provided with a plurality of first slots and a plurality of second slots. Each of the first slots is provided with one tab or two tabs that are spaced, and the second slot is provided with no tab. In a length direction of the current collector, an odd number of second slots are provided between adjacent two of the first slots.

The tab is provided in the first slot, so that when the electrode plate participates in winding to form an electrode assembly of a secondary battery, space occupied by the tab in its extending direction can be reduced, which is conducive to improving energy density of the secondary battery. Moreover, in the length direction of the current collector, an odd number of second slots are provided between adjacent two of the first slots. In this way, when the electrode plate participates in winding to form the electrode assembly of the secondary battery, the first slot and the second slot are made to be located in different side bending sections of the wound structure respectively, so that the possibility of interference between the first slot and the second slot in a thickness of the electrode assembly can be reduced, helping reduce the possibility of interference between tabs of different polarities in the thickness of the electrode assembly.

In the above one or more embodiments, each of the first slots is separately provided with two tabs that are spaced, and the first slot and the second slot are alternately arranged. When the electrode plate participates in winding to form the electrode assembly of the secondary battery, this can allow each winding layer to be provided with a tab.

In the above one or more embodiments, on the side in the width direction of the current collector, the current collector is provided with a third slot, and the third slot is provided with one tab. In the length direction of the current collector, the third slot is provided at an end of the current collector, and an odd number of second slots are provided between the third slot and an adjacent first slot. When the electrode plate participates in winding to form the electrode assembly of the secondary battery, the third slot can be located at the winding starting end, helping the electrode plate fully utilize the space of the innermost winding layer in the winding direction of the electrode plate, thereby helping further improve the energy density of the secondary battery.

In the above one or more embodiments, from one end to the other end in the length direction of the current collector, spacings between the two tabs in the plurality of first slots increase progressively. When the electrode plate participates in winding to form the electrode assembly of the secondary battery, as the number of winding layers increases, a bending section of the wound structure needs to have a larger arc length. From one end to the other end in the length direction of the current collector, making the spacings between the two tabs in the plurality of first slots increase progressively can help make a plurality of tabs with a same polarity located in different winding layers aligned in the thickness direction of the electrode assembly, which is conducive to reducing the space occupied by the tab in its width direction, thereby helping further improve the energy density of the secondary battery.

In the above one or more embodiments, from one end to the other end in the length direction of the current collector, slot widths of the plurality of first slots increase progressively, and slot widths of the plurality of second slots increase progressively. Space occupied by the first slots and the second slots in the length direction of the electrode plate can be reduced. When the electrode plate participates in winding to form the electrode assembly of the secondary battery, this allows the plurality of first slots and the plurality of second slots located in different winding layers to be aligned in the thickness direction of the electrode assembly separately, which is conducive to reducing the space occupied by the first slots and the second slots in the width direction of the tab, thereby helping further improve the energy density of the secondary battery.

In the above one or more embodiments, in the length direction of the current collector, the slot width of the first slot is W₁, and the slot width of the second slot is W₂, satisfying 5 mm≤W₁≤40 mm and 5 mm≤W₂≤40 mm.

In the above one or more embodiments, in the width direction of the current collector, slot depths of the plurality of first slots are equal, slot depths of the plurality of second slots are equal, the slot depth of the first slot is H₁, and the slot depth of the second slot is H₂, satisfying 1 mm≤H₁≤15 mm and 1 mm≤H₂≤15 mm.

In the above one or more embodiments, the tabs and the current collector are integrally formed. When the first slots are processed on the current collector, the tabs can also be conveniently processed, which is conducive to improving the convenience of manufacturing the electrode plate.

In the above one or more embodiments, the electrode plate is a positive electrode plate according to polarity, and the tab is a positive tab according to polarity. The electrode plate further includes insulating members, where the insulating member covers a part of a surface of the positive electrode plate and a part of a surface of the positive tab. When the positive electrode plate participates in winding to form the electrode assembly of the secondary battery, this is conducive to reducing the risk of short circuit caused by burrs on an edge of a negative electrode plate contacting the positive electrode plate or the positive tab.

In the above one or more embodiments, the current collector includes protruding portions each disposed between the first slot and an adjacent second slot, and a surface of the protruding portion is coated with an active material. When the electrode plate participates in winding to form the electrode assembly of the secondary battery, this is conducive to improving the energy density of the secondary battery.

A second aspect of this application provides a secondary battery, including a housing and an electrode assembly, where the electrode assembly is accommodated in the housing. The electrode assembly includes the electrode plates according to the first aspect of this application, where the electrode plates include a positive electrode plate and a negative electrode plate according to different polarities, and the tabs include a positive tab and a negative tab according to different polarities. The first slot of the positive electrode plate is defined as a first positive slot, the second slot of the positive electrode plate is defined as a second positive slot, the first slot of the negative electrode plate is defined as a first negative slot, and the second slot of the negative electrode plate is defined as a second negative slot. The first positive slot is provided with two positive tabs, the second positive slot is provided with no positive tab, the first negative slot is provided with two negative tabs, and the second negative slot is provided with no negative tab. When viewed in a first direction, the electrode assembly has a first notch portion and a second notch portion, the plurality of first positive slots and the plurality of second negative slots are provided in the first notch portion, the plurality of first negative slots and the plurality of second positive slots are provided in the second notch portion, the plurality of positive tabs are led out at the first notch portion, and the plurality of negative tabs are led out at the second notch portion. The first direction is a thickness direction of the electrode assembly.

The plurality of first positive slots and the plurality of second negative slots are provided in the first notch portion, and the plurality of first negative slots and the plurality of second positive slots are provided in the second notch portion, so that the positive tabs in the first positive slots can be provided in the first notch portion and the negative tabs in the first negative slots can be provided in the second notch portion, thereby reducing the space occupied by the tab in its extending direction, which is conducive to improving the energy density of the secondary battery.

In the above one or more embodiments, the electrode assembly includes a separator separating the positive electrode plate and the negative electrode plate, and the positive electrode plate, the negative electrode plate, and the separator are stacked and then wound to form a wound structure.

In the above one or more embodiments, in the first direction, the plurality of positive tabs are gathered to form a first tab bundle, and the plurality of negative tabs are gathered to form a second tab bundle, where the first tab bundle is accommodated in the first notch portion, and the second tab bundle is accommodated in the second notch portion. This can help the first tab bundle not exceed the first notch portion in an extending direction of the positive tab, and help the second tab bundle not exceed the second notch portion in an extending direction of the negative tab, which is conducive to further improving the energy density of the secondary battery.

In the above one or more embodiments, the secondary battery includes a first adapter and a second adapter, where the first adapter connects to the first tab bundle and extends out of the housing, and the second adapter connects to the second tab bundle and extends out of the housing. When the first tab bundle is accommodated in the first notch portion and the second tab bundle is accommodated in the second notch portion, polarities of the electrode assembly can be conveniently led out through the first adapter and the second adapter.

In the above one or more embodiments, the first notch portion and the second notch portion are respectively located at different corners of the electrode assembly. The housing is a flexible packaging bag, where the housing includes a first housing and a second housing, in the first direction, the first housing and the second housing are disposed opposite each other and connected through heat sealing, and a sealing edge portion is formed at a junction between the first housing and the second housing. The sealing edge portion includes a first side sealing portion, a second side sealing portion, and a top sealing portion. When viewed in a second direction, the first adapter and the second adapter are located between the first side sealing portion and the second side sealing portion, and the top sealing portion is located between the first adapter and the second adapter. The second direction is an extending direction of the tab. The first side sealing portion, the second side sealing portion, and the top sealing portion are bent toward a peripheral wall of the electrode assembly. Making the first notch portion and the second notch portion be respectively located at different corners of the electrode assembly can help make the first adapter and the second adapter be respectively disposed at different corners of the housing, which is conducive to reducing the possibility of mutual interference when the first side sealing portion, the second side sealing portion, and the top sealing portion are separately bent toward the peripheral wall of the electrode assembly, and reducing the possibility of interference between the first adapter and the second adapter when the top sealing portion is bent toward the peripheral wall of the electrode assembly, thereby helping reduce the possibility of energy density loss of the secondary battery due to protrusion of the top sealing portion.

In the above one or more embodiments, in the first direction, a projection of the first negative slot falls within a projection range of the second positive slot, and a projection of the second negative slot falls within a projection range of the first positive slot. In a direction perpendicular to the first direction, this can help make the negative electrode plate exceed the positive electrode plate, which is conducive to reducing the risk of lithium precipitation in the secondary battery.

A third aspect of this application provides an electric device, including the secondary battery according to the second aspect of this application. Improving the energy density of the secondary battery is conducive to improving the endurance of the electric device.

### BRIEF DESCRIPTION OF DRAWINGS

FIG. 1 is a schematic structural diagram of an electrode plate according to a first embodiment of this application.

FIG. 2 is a schematic structural diagram of an electrode plate according to a second embodiment of this application.

FIG. 3 is a schematic structural diagram of an electrode plate according to a third embodiment of this application.

FIG. 4 is a schematic structural diagram of an electrode plate according to a fourth embodiment of this application.

FIG. 5 is a schematic structural diagram of an electrode plate according to a fifth embodiment of this application.

FIG. 6 is a schematic diagram of a positive electrode plate and a negative electrode plate being wound with each other according to an embodiment of this application.

FIG. 7 is a schematic diagram of a secondary battery according to an embodiment of this application.

FIG. 8 is a top view of an electrode assembly according to an embodiment of this application.

FIG. 9 is a cross-sectional view along section line A-A in FIG. 8 according to an embodiment of this application.

FIG. 10 is an overall schematic diagram of an electric device according to an embodiment of this application.

Reference signs of main components:

1000. electric device; 100. secondary battery; 10. electrode plate; 101. protruding portion; 10a. positive electrode plate; 10b. negative electrode plate; 11. current collector; 111. first slot; 111a. first positive slot; 111b. first negative slot; 112. second slot; 112a. second positive slot; 112b. second negative slot; 113. third slot; 113a. third positive slot; 113b. third negative slot; 20. tab; 20a. positive tab; 20b. negative tab; 21. first tab bundle; 22. second tab bundle; 30. insulating member; 40. housing; 401. first side sealing portion; 402. second side sealing portion; 403. top sealing portion; 41. first housing; 42. second housing; 50. electrode assembly; 501. first notch portion; 502. second notch portion; 51. separator; 60. first adapter; 70. second adapter; 80. tab adhesive; X. first direction; and Y. second direction.

### DESCRIPTION OF EMBODIMENTS

The following describes the technical solutions in embodiments of this application with reference to the accompanying drawings in the embodiments of this application. Apparently, the described embodiments are only some rather than all of the embodiments of this application.

It should be noted that when one component is assumed as being “connected to” another component, it may be connected to the another component directly or with a component possibly present therebetween. When one component is assumed as being “disposed on/in” another component, the component may be provided directly on/in the another component or with a component possibly present therebetween.

Unless otherwise specified, the term “plurality” used herein refers to two or more than two.

The terms “first”, “second”, and the like are merely intended to distinguish between different objects, and shall not be understood as any indication or implication of relative importance or any implicit indication of the number, sequence or primary-secondary relationship of the technical features indicated.

Unless otherwise defined, all technical and scientific terms used herein shall have the same meanings as commonly understood by those skilled in the art to which this application relates. The terms used herein in the specification of this application are intended to merely describe the specific embodiments rather than to limit this application. The term “and/or” used herein includes any and all combinations of one or more associated items listed.

The following describes some embodiments of this application with reference to the accompanying drawings. In absence of conflicts, the following embodiments and features in the embodiments may be combined.

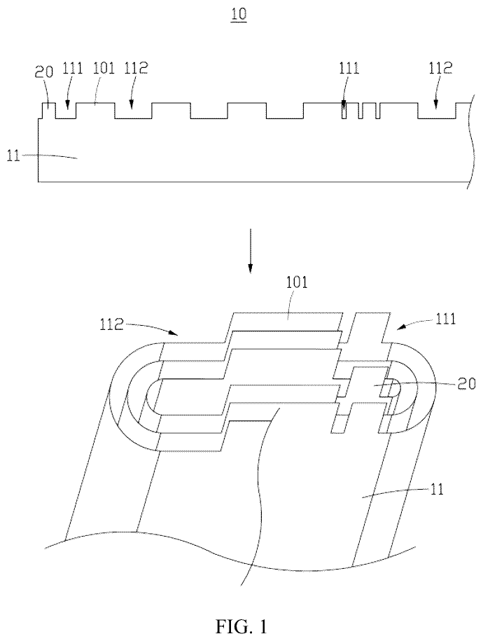

Referring to FIG. 1 to FIG. 5, an embodiment of this application provides an electrode plate 10. The electrode plate 10 includes a current collector 11. On a side in a width direction of the current collector 11, the current collector 11 is provided with a plurality of first slots 111 and a plurality of second slots 112. The forming manner of the first slot 111 and second slot 112 includes but is not limited to cutting the current collector 11. Each of the first slots 111 is provided with one tab 20 or two tabs 20 that are spaced. For example, one part of the first slots 111 are provided with one tab 20, and the other part of the first slots 111 are provided with two tabs 20 that are spaced; or each of the first slots 111 is separately provided with one tab 20; or each of the first slots 111 is separately provided with two tabs 20 that are spaced. The second slot 112 is provided with no tab 20. In a length direction of the current collector 11, an odd number of second slots 112 are provided between adjacent two of the first slots 111. The described odd number refers to a positive odd number, for example, one, three, five, or seven.

In some embodiments, when the first slot 111 is provided with one tab 20, the tab 20 is located on a side of the first slot 111 in a slot depth direction.

In some embodiments, when the first slot 111 is provided with two tabs 20 that are spaced, the two tabs 20 are respectively located on two sides of the first slot 111 in a slot depth direction. In some embodiments, the two tabs 20 in the first slot 111 are symmetrically arranged in the slot depth direction.

The above tab 20 is provided in the first slot 111, so that when the electrode plate 10 participates in winding to form an electrode assembly 50 of a secondary battery 100, space occupied by the tab 20 in its extending direction can be reduced, which is conducive to improving energy density of the secondary battery 100.

As described above, in the length direction of the current collector 11, an odd number of second slots 112 are provided between adjacent two of the first slots 111. In this way, when the electrode plate 10 participates in winding to form the electrode assembly 50 of the secondary battery 100, the first slot 111 and the second slot 112 are made to be located in different side bending sections of the wound structure respectively, so that the possibility of interference between the first slot 111 and the second slot 112 in a thickness of the electrode assembly 50 can be reduced, helping reduce the possibility of interference between tabs 20 of different polarities in the thickness of the electrode assembly 50.

Referring to FIG. 1 to FIG. 5, in some embodiments, the current collector 11 includes protruding portions 101 each disposed between the first slot 111 and an adjacent second slot 112, and a surface of the protruding portion 101 is coated with an active material. When the electrode plate 10 participates in winding to form the electrode assembly 50 of the secondary battery 100, this is conducive to improving the energy density of the secondary battery 100.

In some embodiments, the electrode plate 10 includes active material layers (not shown in the figures), and the active material layers are provided on two surfaces of the current collector 11 that are opposite in the thickness direction.

In some embodiments, each of the first slots 111 is separately provided with two tabs 20 that are spaced, and the first slot 111 and the second slot 112 are alternately arranged. When the electrode plate 10 participates in winding to form the electrode assembly 50 of the secondary battery 100, this can allow each winding layer to be provided with a tab 20. It can be understood that when the first slot 111 and the second slot 112 are alternately arranged, only one second slot 112 is provided between any adjacent two of the first slots 111.

In some embodiments, the tabs 20 and the current collector 11 are integrally formed. When the first slots 111 are processed on the current collector 11, the tabs 20 can also be conveniently processed, which is conducive to improving the convenience of manufacturing the electrode plate 10. The forming manner of the tab 20 includes but is not limited to cutting the current collector 11.

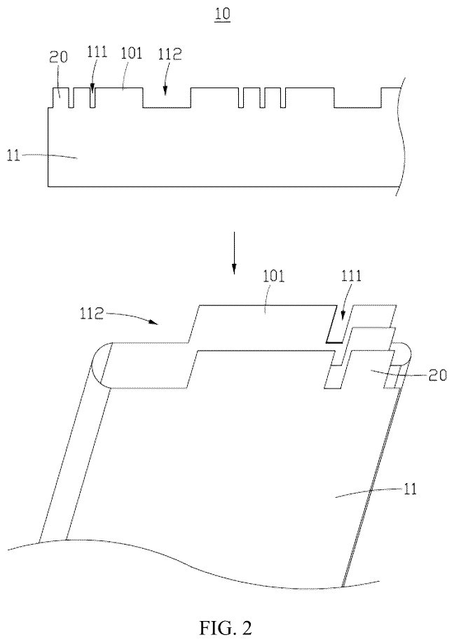

Referring to FIG. 1 or FIG. 2, in some embodiments, the first slot 111 is provided at an end of the current collector 11, that is, an edge of a slot opening of the first slot 111 coincides with a length side of the current collector 11, and an edge of a slot wall of the first slot 111 coincides with a width side of the current collector 11. When the electrode plate 10 of the embodiment shown in FIG. 1 or FIG. 2 participates in winding to form the electrode assembly 50 of the secondary battery 100, in the winding direction of the electrode plate 10, the tab 20 closer to the width side of the current collector 11 and a small part of the current collector 11 are located in the innermost winding layer, and at this time, the innermost winding layer has large space left. It can be understood that in some other embodiments, the second slot 112 is provided at an end of the current collector 11, that is, an edge of a slot opening of the second slot 112 coincides with a length side of the current collector 11, and an edge of a slot wall of the second slot 112 coincides with a width side of the current collector 11.

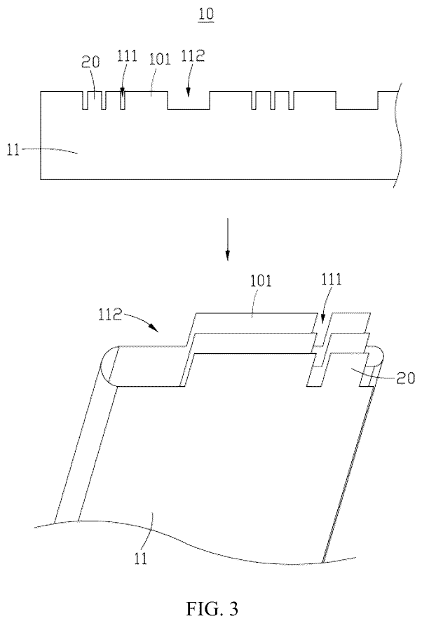

Referring to FIG. 3, in some embodiments, neither the first slot 111 nor the second slot 112 is provided at an end of the current collector 11. When the electrode plate 10 of the embodiment shown in FIG. 3 participates in winding to form the electrode assembly 50 of the secondary battery 100, in the winding direction of the electrode plate 10, the tab 20 closer to the width side of the current collector 11 and a large part of the current collector 11 are located in the innermost winding layer, and at this time, the innermost winding layer still has some space left.

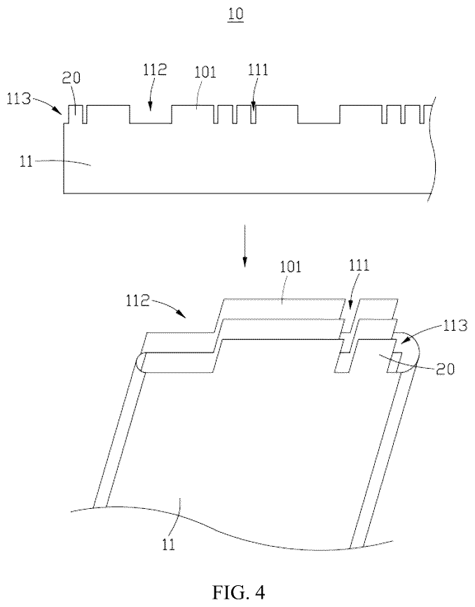

Referring to FIG. 4, in some embodiments, on the side in the width direction of the current collector 11, the current collector 11 is provided with a third slot 113. The forming manner of the third slot 113 includes but is not limited to cutting the current collector 11. The third slot 113 is provided with one tab 20. In the length direction of the current collector 11, the third slot 113 is provided at an end of the current collector 11, and an odd number of second slots 112 are provided between the third slot 113 and an adjacent first slot 111. The described third slot 113 provided at an end of the current collector 11 means that an edge of a slot opening of the third slot 113 coincides with a length side of the current collector 11, and an edge of a slot wall of the third slot 113 coincides with a width side of the current collector 11. The described odd number refers to a positive odd number, for example, one, three, five, or seven. When the electrode plate 10 of the embodiment shown in FIG. 4 participates in winding to form the electrode assembly 50 of the secondary battery 100, the third slot 113 can be located at the winding starting end, helping the electrode plate 10 to fully utilize the space of the innermost winding layer in the winding direction of the electrode plate 10, thereby helping further improve the energy density of the secondary battery 100.

In some embodiments, from one end to the other end in the length direction of the current collector 11, spacings between the two tabs 20 in the plurality of first slots 111 increase progressively. That is, from one end to the other end in the length direction of the current collector 11, a spacing between two tabs 20 in the (N+1)-th first slot 111 is greater than a spacing between two tabs 20 in the N-th first slot 111, where N is a positive integer. When the electrode plate 10 participates in winding to form the electrode assembly 50 of the secondary battery 100, as the number of winding layers increases, a bending section of the wound structure needs to have a larger arc length. From one end to the other end in the length direction of the current collector 11, making the spacings between the two tabs 20 in the plurality of first slots 111 increase progressively can help make a plurality of tabs 20 with a same polarity located in different winding layers aligned in the thickness direction of the electrode assembly 50, which is conducive to reducing the space occupied by the tab 20 in its width direction, thereby helping further improve the energy density of the secondary battery 100.

In some embodiments, from one end to the other end in the length direction of the current collector 11, spacings between the two tabs 20 in the plurality of first slots 111 increase progressively, slot widths of the plurality of first slots 111 are equal, and slot widths of the plurality of second slots 112 are equal. The slot width of the first slot 111 is large enough to accommodate two tabs 20 with the increased spacing reaching the maximum. It can be understood that considering the precision of the manufacture process, when a part by which the maximum value of the slot widths of the plurality of first slots 111 exceeds the minimum value is within an error range of 10% of the minimum value, the slot widths of the plurality of first slots 111 should also be considered equal; and when a part by which the maximum value of the slot widths of the plurality of second slots 112 exceeds the minimum value is within an error range of 10% of the minimum value, the slot widths of the plurality of second slots 112 should also be considered equal.

In some embodiments, from one end to the other end in the length direction of the current collector 11, spacings between the two tabs 20 in the plurality of first slots 111 increase progressively, slot widths of the plurality of first slots 111 increase progressively, and slot widths of the plurality of second slots 112 increase progressively. In this case, the slot widths of the first slots 111 increase progressively as the spacings between the two tabs 20 in the first slots 111 increase progressively, which can reduce the space occupied by the first slots 111 and the second slots 112 in the length direction of the electrode plate 10. When the electrode plate 10 participates in winding to form the electrode assembly 50 of the secondary battery 100, this allows the plurality of first slots 111 and the plurality of second slots 112 located in different winding layers to be aligned in the thickness direction of the electrode assembly 50 separately, which is conducive to reducing the space occupied by the first slots 111 and the second slots 112 in the width direction of the tab 20, thereby helping further improve the energy density of the secondary battery 100.

In some embodiments, in the length direction of the current collector 11, the slot width of the first slot 111 is W₁, and the slot width of the second slot 112 is W₂, satisfying 5 mm ≤W₁≤40 mm and 5 mm≤W₂≤40 mm. For example, W₁ is 5 mm, 10 mm, 15 mm, 20 mm, 25 mm, 30 mm, 35 mm, 40 mm, or any value between the listed endpoint values, and W₂ is 5 mm, 10 mm, 15 mm, 20 mm, 25 mm, 30 mm, 35 mm, 40 mm, or any value between the listed endpoint values.

In some embodiments, in the width direction of the current collector 11, slot depths of the plurality of first slots 111 are equal, and slot depths of the plurality of second slots 112 are equal. It can be understood that considering the precision of the manufacture process, when a part by which the maximum value of the slot depths of the plurality of first slots 111 exceeds the minimum value is within an error range of 10% of the minimum value, the slot depths of the plurality of first slots 111 should also be considered equal; and when a part by which the maximum value of the slot depths of the plurality of second slots 112 exceeds the minimum value is within an error range of 10% of the minimum value, the slot depths of the plurality of second slots 112 should also be considered equal.

In some embodiments, in the width direction of the current collector 11, slot depths of the plurality of first slots 111 are equal, slot depths of the plurality of second slots 112 are equal, the slot depth of the first slot 111 is H₁, and the slot depth of the second slot 112 is H₂, satisfying 1 mm≤H₁≤15 mm and 1 mm≤H₂≤15 mm. For example, H₁ is 1 mm, 2 mm, 3 mm, 5 mm, 10 mm, 15 mm, or any value between the listed endpoint values, and H₂ is 1 mm, 2 mm, 3 mm, 5 mm, 10 mm, 15 mm, or any value between the listed endpoint values.

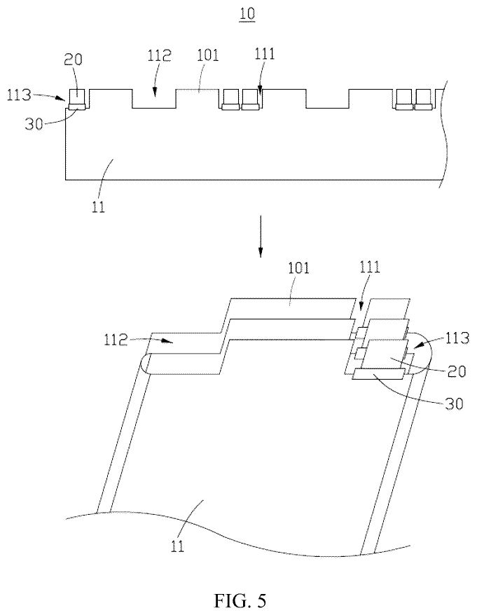

Referring to FIG. 5, in some embodiments, the electrode plate 10 further includes insulating members 30, where the insulating member 30 covers a part of a surface of the electrode plate 10 and a part of a surface of the tab 20. In some embodiments, the insulating member 30 covers a part of a surface of the electrode plate 10 and a part of a surface of the tab 20 in the thickness direction of the electrode plate 10.

In some embodiments, the insulating member 30 includes but is not limited to insulation adhesive, and the insulation adhesive is attached to a part of the surface of the electrode plate 10 and a part of the surface of the tab 20. In some embodiments, the insulating member 30 is formed by spraying an insulating material on a part of the surface of the electrode plate 10 and a part of the surface of the tab 20. The insulating material includes but is not limited to a polymer material such as polypropylene, polyethylene terephthalate, or polyethylene.

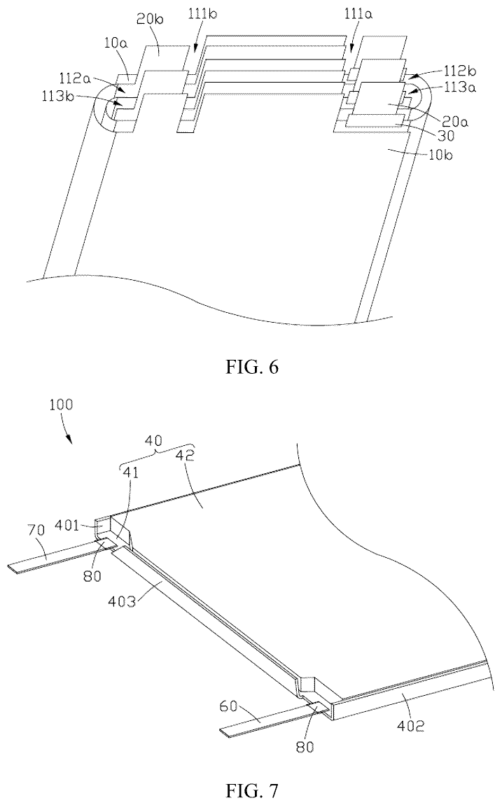

In some embodiments, the electrode plate 10 is a positive electrode plate 10a according to polarity, and the tab 20 is a positive tab 20a according to polarity. In some embodiments, the electrode plate 10 is a negative electrode plate 10b according to polarity, and the tab 20 is a negative tab 20b according to polarity. Referring to FIG. 6, the positive electrode plate 10a and the negative electrode plate 10b jointly participate in winding to form the electrode assembly 50 of the secondary battery 100.

In some embodiments, the electrode plate 10 is a positive electrode plate 10a according to polarity, and the tab 20 is a positive tab 20a according to polarity. The insulating member 30 covers a part of a surface of the positive electrode plate 10a and a part of a surface of the positive tab 20a. When the positive electrode plate 10a participates in winding to form the electrode assembly 50 of the secondary battery 100, this is conducive to reducing the risk of short circuit caused by burrs on an edge of the negative electrode plate 10b contacting the positive electrode plate 10a or the positive tab 20a.

The first slot 111 of the positive electrode plate 10a is defined as a first positive slot 111a, the second slot 112 of the positive electrode plate 10a is defined as a second positive slot 112a, the first slot 111 of the negative electrode plate 10b is defined as a first negative slot 111b, and the second slot 112 of the negative electrode plate 10b is defined as a second negative slot 112b. The first positive slot 111a is provided with two positive tabs 20a, the second positive slot 112a is provided with no positive tab 20a, the first negative slot 111b is provided with two negative tabs 20b, and the second negative slot 112b is provided with no negative tab 20b. In the electrode assembly 50 formed by winding jointly participated by the positive electrode plate 10a and the negative electrode plate 10b, when viewed in the thickness direction of the electrode assembly 50, the first positive slot 111a, the second negative slot 112b, and the positive tab 20a are located on one side of the electrode assembly 50 and overlap each other, and the first negative slot 111b, the second positive slot 112a, and the negative tab 20b are located on the other side of the electrode assembly 50 and overlap each other.

When the current collector 11 is provided with a third slot 113, the third slot 113 of the positive electrode plate 10a is defined as a third positive slot 113a, the third slot 113 of the negative electrode plate 10b is defined as a third negative slot 113b, the third positive slot 113a is provided with one positive tab 20a, and the third negative slot 113b is provided with one negative tab 20b. Referring to FIG. 5, when viewed in the thickness direction of the electrode assembly 50, the third positive slot 113a, the second negative slot 112b, the first positive slot 111a, and the positive tab 20a are located on one side of the electrode assembly 50 and overlap each other, and the third negative slot 113b, the second positive slot 112a, the first negative slot 111b, and the negative tab 20b are located on the other side of the electrode assembly 50 and overlap each other.

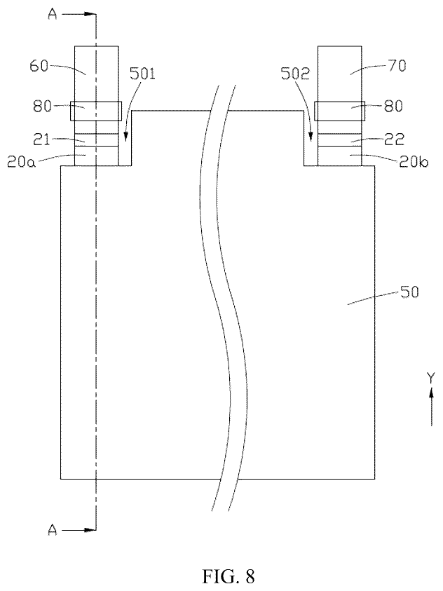

Referring to FIG. 7 and FIG. 8, an embodiment of this application provides a secondary battery 100, including a housing 40 and an electrode assembly 50, where the electrode assembly 50 is accommodated in the housing 40. The electrode assembly 50 includes the positive electrode plate 10a and the negative electrode plate 10b described above.

When viewed in a first direction X, the electrode assembly 50 has a first notch portion 501 and a second notch portion 502 (see FIG. 8). Referring to FIG. 6 and FIG. 8, the plurality of first positive slots 111a and the plurality of second negative slots 112b are provided in the first notch portion 501, the plurality of first negative slots 111b and the plurality of second positive slots 112a are provided in the second notch portion 502, the plurality of positive tabs 20a are led out at the first notch portion 501, and the plurality of negative tabs 20b are led out at the second notch portion 502. The first direction X is a thickness direction of the electrode assembly 50. The plurality of first positive slots 111a and the plurality of second negative slots 112b are provided in the first notch portion 501, and the plurality of first negative slots 111b and the plurality of second positive slots 112a are provided in the second notch portion 502, so that the positive tabs 20a in the first positive slots 111a can be provided in the first notch portion 501 and the negative tabs 20b in the first negative slots 111b can be provided in the second notch portion 502, thereby reducing the space occupied by the tab 20 in its extending direction, which is conducive to improving the energy density of the secondary battery 100.

In some embodiments, in the first direction X, a projection of the first negative slot 111b falls within a projection range of the second positive slot 112a, and a projection of the second negative slot 112b falls within a projection range of the first positive slot 111a. In a direction perpendicular to the first direction X, this can help make the negative electrode plate 10b exceed the positive electrode plate 10a, which is conducive to reducing the risk of lithium precipitation in the secondary battery 100.

Referring to FIG. 8, in some embodiments, the first notch portion 501 and the second notch portion 502 are respectively located at different corners of the electrode assembly 50. The described corner refers to an intersection angle between a length side edge and a width side edge of the electrode assembly 50. Generally, the electrode assembly 50 has four corners, and the first notch portion 501 and the second notch portion 502 are respectively located at two corners opposite each other in the length direction or width direction of the electrode assembly 50, rather than respectively located at two diagonally opposite corners.

In some embodiments, the housing 40 is a metal housing, and the metal housing includes but is not limited to a steel shell. In some embodiments, the housing 40 is a flexible packaging bag, and the flexible packaging bag includes but is not limited to an aluminum-plastic film. The housing 40 includes a first housing 41 and a second housing 42. In the first direction X, the first housing 41 and the second housing 42 are disposed opposite each other. In some embodiments, the housing 40 is a metal housing, and the first housing 41 and the second housing 42 are connected through welding. In some embodiments, the housing 40 is a flexible packaging bag, and the first housing 41 and the second housing 42 are connected through heat sealing.

In some embodiments, the housing 40 is a metal housing, and the first housing 41 and the second housing 42 are insulated from each other. A positive electrode of the electrode assembly 50 is electrically connected to one of the first housing 41 and the second housing 42, and a negative electrode of the electrode assembly 50 is electrically connected to the other of the first housing 41 and the second housing 42. Materials of the first housing 41 and the second housing 42 may be the same or different.

In some embodiments, the housing 40 is a metal housing, and the first housing 41 and the second housing 42 are conductively provided. The secondary battery 100 includes a terminal post (not shown in the figures), and the terminal post is provided on and insulated from the housing 40. One of the positive electrode and the negative electrode of the electrode assembly 50 is electrically connected to the housing 40, and the other of the positive electrode and the negative electrode of the electrode assembly 50 is electrically connected to the terminal post. In some other embodiments, the positive electrode and the negative electrode of the electrode assembly 50 are respectively electrically connected to different terminal posts.

In some embodiments, in the first direction X, the plurality of positive tabs 20a are gathered to form a first tab bundle 21, and the plurality of negative tabs 20b are gathered to form a second tab bundle 22. In some embodiments, the first tab bundle 21 is bent in a direction opposite to the gathering direction, and the second tab bundle 22 is bent in a direction opposite to the gathering direction.

In some embodiments, the first tab bundle 21 is accommodated in the first notch portion 501, and the second tab bundle 22 is accommodated in the second notch portion 502. This can help the first tab bundle 21 not exceed the first notch portion 501 in an extending direction of the positive tab 20a, and help the second tab bundle 22 not exceed the second notch portion 502 in an extending direction of the negative tab 20b, which is conducive to further improving the energy density of the secondary battery 100.

In some embodiments, the housing 40 is a metal housing, and a terminal post is provided on and insulated from the housing 40. The first tab bundle 21 is connected to the housing 40, and the second tab bundle 22 is connected to the terminal post; or the first tab bundle 21 is connected to the terminal post, and the second tab bundle 22 is connected to the housing 40. The connection manner includes but is not limited to welding.

In some embodiments, the housing 40 is a flexible packaging bag, and the secondary battery 100 includes a first adapter 60 and a second adapter 70, where the first adapter 60 connects to the first tab bundle 21 and extends out of the housing 40, and the second adapter 70 connects to the second tab bundle 22 and extends out of the housing 40. The connection manner includes but is not limited to welding. When the first tab bundle 21 is accommodated in the first notch portion 501 and the second tab bundle 22 is accommodated in the second notch portion 502, polarities of the electrode assembly 50 can be conveniently led out through the first adapter 60 and the second adapter 70. In some embodiments, materials of the first adapter 60 and the second adapter 70 include one or more of conductive materials such as copper, aluminum, nickel, and nickel alloy.

In some embodiments, the first notch portion 501 and the second notch portion 502 are respectively located at different corners of the electrode assembly 50. The housing 40 is a flexible packaging bag. The first housing 41 and the second housing 42 are connected through heat sealing. A sealing edge portion is formed at a junction between the first housing 41 and the second housing 42. The sealing edge portion includes a first side sealing portion 401, a second side sealing portion 402, and a top sealing portion 403. When viewed in a second direction Y, the first adapter 60 and the second adapter 70 are located between the first side sealing portion 401 and the second side sealing portion 402, and the top sealing portion 403 is located between the first adapter 60 and the second adapter 70. The second direction Y is an extending direction of the tab 20. The first side sealing portion 401, the second side sealing portion 402, and the top sealing portion 403 are bent toward a peripheral wall of the electrode assembly 50. Making the first notch portion 501 and the second notch portion 502 be respectively located at different corners of the electrode assembly 50 can help make the first adapter 60 and the second adapter 70 be respectively provided at different corners of the housing 40, which is conducive to reducing the possibility of mutual interference when the first side sealing portion 401, the second side sealing portion 402, and the top sealing portion 403 are separately bent toward the peripheral wall of the electrode assembly 50, and reducing the possibility of interference between the first adapter 60 and the second adapter 70 when the top sealing portion 403 is bent toward the peripheral wall of the electrode assembly 50, thereby helping reduce the possibility of energy density loss of the secondary battery 100 due to protrusion of the top sealing portion 403.

In some embodiments, the housing 40 is a flexible packaging bag, and the first housing 41 and the second housing 42 are connected through heat sealing. The first adapter 60 connects to the first tab bundle 21 and extends out of the housing 40, and the second adapter 70 connects to the second tab bundle 22 and extends out of the housing 40. The secondary battery 100 includes a tab adhesive 80, where the tab adhesive 80 is provided around an outer periphery of the first adapter 60 and an outer periphery of the second adapter 70, so that the first adapter 60 and the second adapter 70 can sealingly connect to the housing 40 separately.

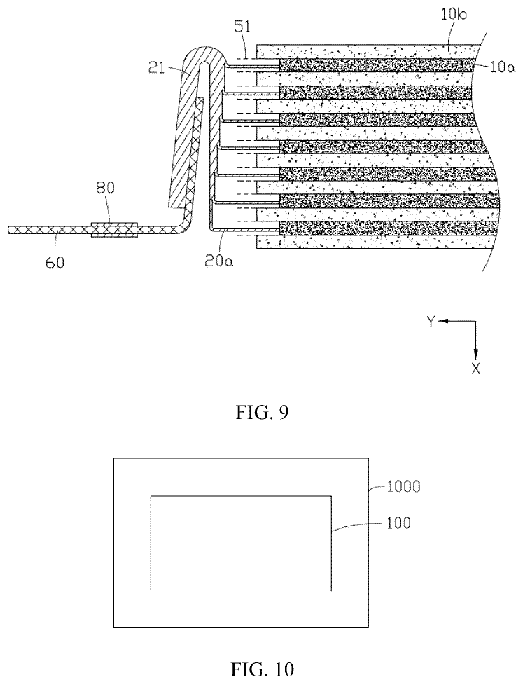

In some embodiments, the first housing 41 and the second housing 42 jointly form an accommodating cavity, an electrolyte is filled in the accommodating cavity, and the electrode assembly 50 is provided in the accommodating cavity. Referring to FIG. 9, the electrode assembly 50 includes a separator 51, where the separator 51 separates the positive electrode plate 10a and the negative electrode plate 10b. The positive electrode plate 10a, the negative electrode plate 10b, and the separator 51 are stacked and then wound to form a wound structure.

In some embodiments, the positive electrode plate 10a includes a positive current collector and a positive electrode active substance layer, where the positive electrode active substance layer is provided on two opposite surfaces of the positive current collector in the thickness direction. A material of the positive current collector includes but is not limited to aluminum foil. The positive electrode active substance layer may be formed by applying a positive electrode active substance material on the positive current collector, and the positive electrode active substance layer is bonded to the positive current collector.

In some embodiments, the negative electrode plate 10b includes a negative current collector and a negative electrode active substance layer, where the negative electrode active substance layer is provided on two opposite surfaces of the negative current collector in the thickness direction. A material of the negative current collector includes but is not limited to copper foil. The negative electrode active substance layer may be formed by applying a negative electrode active substance material on the negative current collector, and the negative electrode active substance layer is bonded to the negative current collector.

In some embodiments, the separator 51 is an insulating film material such as a polyethylene film, a polypropylene film, a polyester film, or a polyimide film.

Referring to FIG. 10, an embodiment of this application provides an electric device 1000, including the foregoing secondary battery 100. Improving the energy density of the secondary battery 100 is conducive to improving the endurance capability of the electric device 1000. The electric device 1000 includes but is not limited to an electronic device such as an electronic book player, a mobile phone, a fax machine, a copier, a printer, a headset, a video recorder, a liquid crystal display television, a recorder, a radio, a camera, a tablet computer, or a notebook computer.

In addition, those of ordinary skill in the art should appreciate that the foregoing embodiments are for description of this application only but not for limiting this application. Appropriate modifications and variations made to the embodiments without departing from the essential scope of this application all fall within the scope of this application.

What is claimed is:

1. An electrode plate, comprising: a current collector; wherein on a side in a width direction of the current collector, the current collector is provided with a plurality of first slots and a plurality of second slots; each of the first slots is provided with one tab or two tabs spaced from each other, and each second slot is provided with no tab;
and in a length direction of the current collector, an odd number of second slots are provided between adjacent two of the first slots.

2. The electrode plate according to claim 1, wherein the each of the first slots is provided with the two tabs spaced from each other, and the plurality of first slots and the plurality of second slots are alternately arranged.

3. The electrode plate according to claim 1, wherein on the side in the width direction of the current collector, the current collector is further provided with a third slot; the third slot is provided with one tab; and in the length direction of the current collector, the third slot is provided at an end of the current collector, and an odd number of second slots are provided between the third slot and an adjacent first slot.

4. The electrode plate according to claim 1, wherein from one end to the other end in the length direction of the current collector, spacings between the two tabs in the plurality of first slots increase gradually.

5. The electrode plate according to claim 4, wherein from one end to the other end in the length direction of the current collector, slot widths of the plurality of first slots increase gradually, and slot widths of the plurality of second slots increase gradually.

6. The electrode plate according to claim 5, wherein in the length direction of the current collector, the slot width of the each first slot is in a range of 5 mm to 40 mm, and the slot width of the each second slot is in a range of 5 mm to 40 mm.

7. The electrode plate according to claim 6, wherein the slot width of the each first slot is in a range of 10 mm to 30 mm, and the slot width of the each second slot is in a range of 10 mm to 30 mm.

8. The electrode plate according to claim 1, wherein in the width direction of the current collector, slot depths of the plurality of first slots are equal, slot depths of the plurality of second slots are equal, the slot depth of the first slot is H₁, and the slot depth of the second slot is H₂, and 1 mm≤H₁≤15 mm and 1 mm≤H₂≤15 mm.

9. The electrode plate according to claim 7, wherein 2 mm≤H₁≤10 mm and 2 mm≤H₂≤10 mm.

10. The electrode plate according to claim 1, wherein the tabs and the current collector re integrally formed.

11. The electrode plate according to claim 1, wherein the electrode plate is a positive electrode plate according to polarity; and the tab is a positive tab according to polarity; and the electrode plate further comprises insulating members, the insulating member covering a part of a surface of the positive electrode plate and a part of a surface of the positive tab.

12. The electrode plate according to claim 2, wherein the electrode plate is a positive electrode plate according to polarity, and the tab is a positive tab according to polarity; and the electrode plate further comprises insulating members, the insulating member covering a part of a surface of the positive electrode plate and a part of a surface of the positive tab.

13. The electrode plate according to claim 1, wherein the current collector comprises protruding portions; each protruding portion is disposed between one of the first slots and an adjacent second slot; and a surface of the protruding portion is coated with an active material.

14. A secondary battery, comprising:
a housing;
an electrode assembly, accommodated in the housing wherein the electrode assembly comprises the electrode plates according to claim 1, the electrode plates comprise a positive electrode plate and a negative electrode plate according to different polarities, and the tabs comprise a positive tab and a negative tab according to different polarities; the first slot of the positive electrode plate is defined as a first positive slot, the second slot of the positive electrode plate is defined as a second positive slot, the first slot of the negative electrode plate is defined as a first negative slot; the second slot of the negative electrode plate is defined as a second negative slot, the first positive slot is provided with two positive tabs, the second positive slot is provided with no positive tab, the first negative slot is provided with two negative tabs, and the second negative slot is provided with no negative tab; and when viewed in a first direction, the electrode assembly has a first notch portion and a second notch portion; the plurality of first positive slots and the plurality of second negative slots are provided in the first notch portion, the plurality of first negative slots and the plurality of second positive slots are provided in the second notch portion, the plurality of positive tabs are led out at the first notch portion, the plurality of negative tabs are led out at the second notch portion, and the first direction is a thickness direction of the electrode assembly.

15. The secondary battery according to claim 14, wherein the electrode assembly comprises a separator separating the positive electrode plate and the negative electrode plate; the positive electrode plate, the negative electrode plate, and the separator are stacked and then wound to form a wound structure.

16. The secondary battery according to claim 15, wherein in the first direction, the plurality of positive tabs are gathered to form a first tab bundle; the plurality of negative tabs are gathered to form a second tab bundle; the first tab bundle being accommodated in the first notch portion, and the second tab bundle being accommodated in the second notch portion.

17. The secondary battery according to claim 16, wherein the secondary battery comprises a first adapter and a second adapter, the first adapter connects to the first tab bundle and extends out of the housing, and the second adapter connects to the second tab bundle and extends out of the housing.

18. The secondary battery according to claim 17, wherein the first notch portion and the second notch portion are respectively located at different corners of the electrode assembly; and
the housing is a flexible packaging bag; wherein the housing comprises a first housing and a second housing; in the first direction, the first housing and the second housing are disposed opposite each other and connected through heat sealing, and a sealing edge portion is formed at a junction between the first housing and the second housing; the sealing edge portion comprises a first side sealing portion, a second side sealing portion, and a top sealing portion, and when viewed in a second direction, the first adapter and the second adapter are located between the first side sealing portion and the second side sealing portion, the top sealing portion is located between the first adapter and the second adapter, and the second direction is an extending direction of the tab; and the first side sealing portion, the second side sealing portion, and the top sealing portion are bent toward a peripheral wall of the electrode assembly.

19. The secondary battery according to claim 18, wherein in the first direction, a projection of the first negative slot falls within a projection range of the second positive slot, and a projection of the second negative slot falls within a projection range of the first positive slot.

20. An electric device comprising the secondary battery according to claim 18.
